(19) United States
(12) Patent Application Publication
(10) Pub. No.: US 2007/0200351 A1
(43) Pub. Date: Aug. 30, 2007

(54) PLANT FACILITY

(76) Inventors: Masakazu Miyagi, Hitachi (JP); Tetsuo Sasada, Hitachi (JP); Isao Takehara, Hitachi (JP); Hidetaro Murata, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/627,624

(22) Filed: Jan. 26, 2007

(30) Foreign Application Priority Data
Feb. 7, 2006 (JP) 2006-029505

(51) Int. Cl. F01D 15/10; H02P 9/04

(52) U.S. Cl. 290/52

(57) ABSTRACT

To provide a plant facility which requires no transmission such as reduction gear and speed up gear, thus increasing the plant efficiency. The plant facility has a turbine which rotates at a frequency higher than the electrical power supply frequency, a generator which is directly connected to the turbine and rotates at the same rotating speed with that of the turbine, and an electrical motor which is directly connected to a load apparatus and driven by electricity at a frequency higher than the electrical power supply frequency generated from the generator. The load apparatus is driven at the same rotating speed with that of the electrical motor.

### BACKGROUND OF THE INVENTION

1. Field of the Invention

The present invention relates to a plant facility which drives a load apparatus by electricity generated from an electric power facility.

2. Description of the Related Art

There are known technologies that drive an electrical motor by electricity generated from a generator driven by a turbine, thus driving a load apparatus using the power of the electrical motor. An example of that type of technology is dis closed in JP-A-2000-104698 (Patent Document 1).

### SUMMARY OF THE INVENTION

The above convention al technology dis closed in JP-A-2000-104698 places a reduction gear between a gas turbine and a generator, and a speed up gear is located between a motor and a gas compressor. Therefore, the efficiency of plant facility is decreased due to the power loss generated in transmission such as the reduction gear and the speed up gear.

The present invention has been made to solve the above problem, and an object of the present invention is to provide a plant facility which requires no transmission, thus increasing the plant efficiency.

To achieve the above object, the plant facility according to the present invention has a turbine which rotates at a frequency higher than an electrical power supply frequency, a generator which is directly connected to the turbine and rotates at the same rotating speed with that of the turbine, and an electrical motor which is directly connected to a load apparatus and driven by electricity at a frequency higher than the electrical power supply frequency generated from the generator, while the load apparatus is driven at the same rotating speed with that of the electrical motor.

The present invention has an effect of providing a plant facility which requires no transmission such as reduction gear and speed up gear, thereby increasing the plant efficiency.

### BRIEF DESCRIPTION OF THE DRAWINGS

FIG. 1 shows a total structure of plant facility as an example of the present invention.

FIG. 2 shows a total structure of plant facility as another example of the present invention.

FIG. 3 shows a total structure of plant facility as further example of the present invention.

FIG. 4 shows a total structure of plant facility as still another example of the present invention.

FIG. 5 shows a total structure of plant facility as still further example of the present invention.

FIG. 6 shows a total structure of plant facility as other example of the present invention.

FIG. 7 shows a total structure of plant facility as still other example of the present invention.

FIG. 8 shows a total structure of a common plant facility.

### DESCRIPTION OF THE PREFERRED EMBODIMENTS

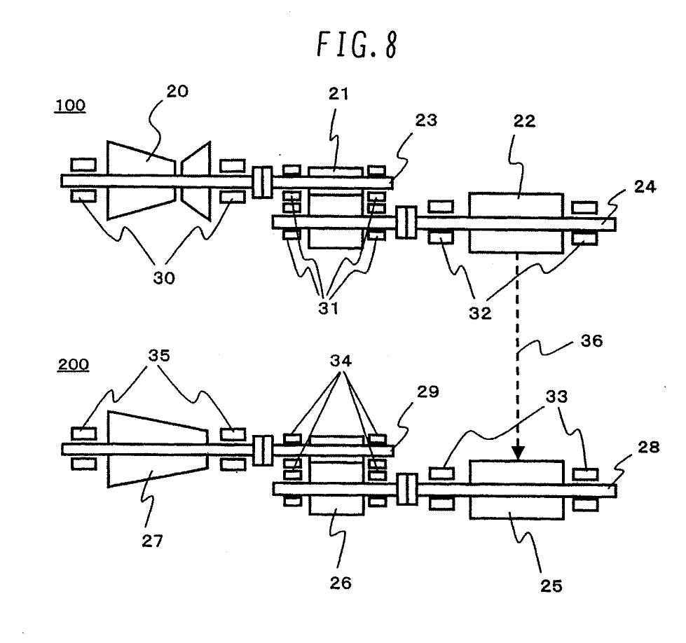

Before describing the examples of the present invention, a common plant facility will be described referring to FIG. 8. Although the following description is an example of using gas turbine as the electric power facility, an electric power facility using a steam turbine is also applicable. The load driven by a motor is a gas compressor in this example. Nevertheless, pump and other load apparatuses are also applicable.

The plant facility shown in FIG. 8 is largely divided into a generator side facility 100 and a load side facility 200. The generator side facility 100 has a gas turbine 20 as the electric power facility and a generator 22 which is driven by the gas turbine 20, as the main apparatuses. The power generated by the gas turbine 20 is transmitted from a gas turbine rotating shaft 23 to a generator rotating shaft 24 via a reduction gear 21. The reduction gear 21 adjusts the rotating speed being transmitted to the generator 22 so as the electric power generated from the generator 22 to have the electrical power supply frequency, (50 Hz or 60 Hz). The rotating shaft of each of the gas turbine 20, the reduction gear 21, and the generator 22 is supported by the respective bearings 30, 31, and 32.

The load side facility 200 has an electrical motor 25 which is driven by electricity 36 having the electrical power supply frequency supplied from the generator 22, and a gas compressor 27 which is driven by the electrical motor 25. The power generated from the electrical motor 25 is transmitted from an electrical motor rotating shaft 28 to a gas compressor rotating shaft 29 via a speed up gear 26. The rotating shaft of each of the electrical motor 25, the speed up gear 26, and the gas compressor 27 is supported by the respective be a rings 33, 34, and 35.

The plant facility having the above structure uses the gas compressor 27 as the load apparatus to compress the gas to a high pressure. In addition, the plant facility has a gas turbine electrical power facility to generate the electricity for driving the electrical motor 25 by the generator 22. In general, the gas turbine for power generation in a plant facility is at a relatively medium to small scale. Although a large scale gas turbine is designed to bring the rotating speed to correspond to 50 Hz or 60 Hz, which is the electrical power supply frequency, the gas turbine of middle to small scale is normally operated at a high rotating speed, corresponding to 60 Hz or higher frequency, to optimize the thermal efficiency.

When the generator 22 is a 2-pole generator, it rotates at 50 Hz or 60 Hz, which is the electrical power supply frequency. If the number of poles increases to, for example, four, the rotating speed further decreases. Accordingly, medium to small scale gas turbine electric power facility adopts the reduction gear 21 so as to be positioned between the gas turbine 20 and the generator 22, thereby matching the rotating speed of the gas turbine rotating shaft 23 with that of the generator rotating shaft 24.

Since the reduction gear 21 of the gas turbine electrical power facility is structured by a pinion and gear, the power generation efficiency decreases owing to gear meshing loss and windage loss. Furthermore, since the gears are supported by the reduction gear bearings 31, the bearing loss is generated, which also decreases the power generation efficiency. In addition, gears and bearings need a large volume of lube oil, which increases the capacity of lube oil system equipment such as tank, pump, filter, and cooler, and further increases the number of various valves and the piping length, causing additional disadvantage.

The electricity 36 having the electrical power supply frequency, (50 Hz or 60 Hz), generated from the gas turbine electric power facility is sent to the electrical motor 25 in the same plant, thus actuating the electrical motor 25. The driven electrical motor 25 then drives the gas compressor 27 to perform necessary work. The rotating speed of the electrical motor 25 is normally 50 Hz or 60 Hz, which is the electrical power supply frequency. On the other hand, since the gas compressor 27 achieves higher efficiency at higher rotating speed, it is generally driven at higher rotating speed than 60 Hz. Accordingly, the speed up gear 26 is located between the electrical motor 25 and the gas compressor 27 to increase the rotating speed transmitted from the electrical motor rotating shaft 28 by the speed up gear 26 so as the gas compressor rotating shaft 29 to rotate at a desired speed.

Similar to the reduction gear 21, since the speed up gear 26 is structured by a pinion and gear, the power generation efficiency decreases owing to gear meshing loss and windage loss. Furthermore, since the gears are supported by the speed up gear bearings 34, the bearing loss is generated, which also decreases the power generation efficiency. In addition, gears and bearings need a large volume of lube oil, which increases the capacity of lube oil system equipment such as tank, pump, filter, and cooler, and further increases the number of various valves and the piping length, causing additional disadvantage.

### First Embodiment

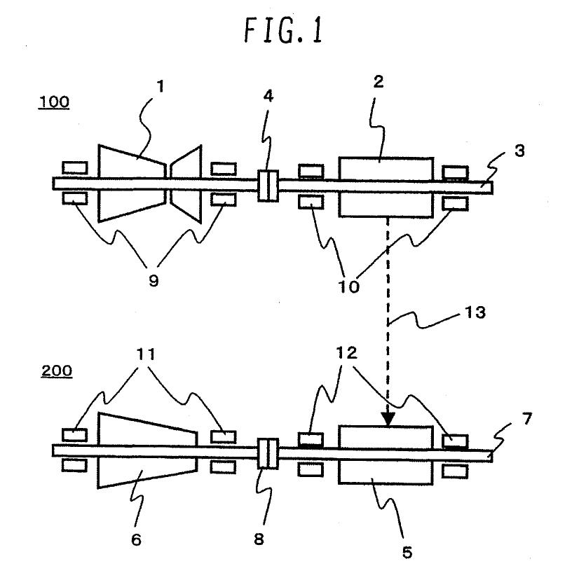

Preferred embodiments of the present invention will be described below in detail referring to the drawings. FIG. 1 shows a total structure of an example of the plant facility according to the present invention.

The structure of example given in FIG. 1 is, similar to the structure of FIG. 8, largely divided into the generator side facility 100 and the load side facility 200. The generator side facility 100 has a gas turbine 1 as the electric power facility and a generator 2 which is driven by the gas turbine, as the main apparatuses. Each of the rotating shafts of the gas turbine 1 and the generator 2 is supported by bearings 9 and 10, respectively. According to the example, the gas turbine rotating shaft and the generator rotating shaft are connected by a directly-connected coupling 4, thus integrated mechanically as a gas turbine-generator rotating shaft 3.

The load side facility 200 has an electrical motor 5 which is driven by electricity 13, having the electrical power supply frequency, supplied from the generator 2, and a gas compressor 6 which is driven by the electrical motor 5. The rotating shafts of the electrical motor 5 and the gas compressor 6 are supported by the bearings 11 and 12 respectively. Also in the load side facility 200, the electrical motor rotating shaft and the gas compressor rotating shaft are connected by a directly-connected coupling 8, thus integrated mechanically as an electrical motor-gas compressor rotating shaft 7.

According to the example having the above structure, similar to the structure of FIG. 8, the gas turbine 1 drives the generator 2 to generate electricity 13, the electricity 13 then drives the electrical motor 5 to drive the gas compressor 6.

The difference of the example from the structure of FIG. 8 is that the generator side facility 100 and the load side facility 200 have no transmission. That is, the rotating shafts of the gas turbine 1 and the generator 2 are directly connected with each other without inserting reduction gear therebetween, and the rotating shafts of the electrical motor 5 and the gas compressor 6 are also directly connected with each other without inserting speed up gear therebetween. The rotating speed (X Hz) of the gas turbine 1 is higher than 60 Hz, and the rotating speed of the generator 2 is also X Hz. Consequently, the frequency of electricity generated from the generator 2 also becomes X Hz, (for the case of 2-pole generator).

The electricity 13 of X Hz is sent to the electrical motor 5 in the same plant, thus actuating the electrical motor 5. The electrical motor 5 is designed to be driven by the electricity 13 of X Hz, and the rotating speed of the electrical motor is X Hz. The electrical motor 5 drives the gas compressor 6 to perform a desired work. The electrical motor 5 in FIG. 1, however, differs from the example of FIG. 8, and gives a rotating speed of X Hz which is larger than ordinary electrical power supply frequency of 50 Hz or 60 Hz. As a result, the electrical motor 5 is able to be directly connected to the gas compressor 6 without inserting a speed up gear therebetween.

With the above-described example, convention ally installed reduction gear and speed up gear can be eliminated without decreasing the efficiency of each unit of equipment such as gas turbine 1, generator 2, electrical motor 5, and gas compressor 6. Although reduction gear and speed up gear generate loss such as gear meshing loss, windage loss, and bearing loss, the example does not induce above loss because the example does not use either reduction gear or speed up gear. Furthermore, the elimination of reduction gear and speed up gear eliminates the use of lube oil which is necessary in conventional facility. This can decrease the capacity of lube oil system equipment such as tank, pump, filter, and cooler becomes small, and further the power of auxiliary machines such as pump. As a result, there is attained an effect of increasing the plant facility efficiency.

The reduction in the number of lube oil system equipment owing to the elimination of reduction gear and speed up gear decreases the number of various valves and the length of piping, thus reducing the cost. With the elimination of reduction gear and speed up gear, and with the decrease in the capacity of lube oil system equipment, the installation are a of the plant facility can be decreased.

There are several applicable methods for selecting the rotating speed (X Hz) of the rotating shaft of gas turbine and generator 3 and the rotating shaft of electrical motor and gas compressor 7. Since, however, the gas turbine 1 and the gas compressor 6 have the respective optimum rotating speeds for maximizing the efficiency depending on their output, a rotating speed which maximizes the plant efficiency is selected.

### Second Embodiment

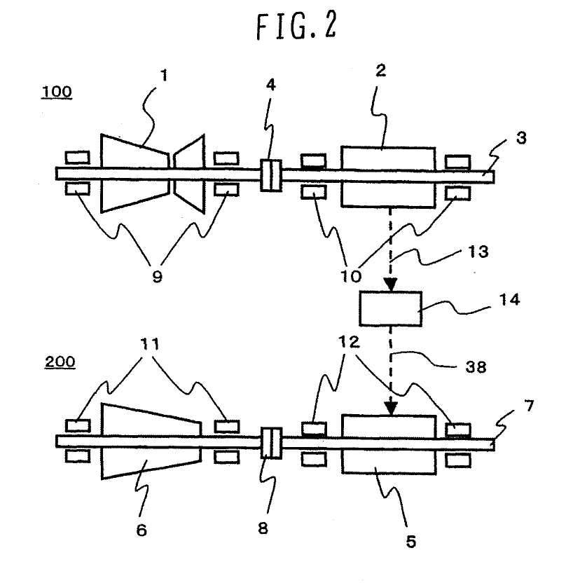

FIG. 2 shows another example of the present invention. The example has a structure of, adding to the structure of FIG. 1, adopting an inverter 14 which varies the frequency of electricity 13 supplied from the generator 2 to the electrical motor 5.

In the example, the rotating speed (X Hz) of the gas turbine 1 is higher than 60 Hz, and the rotating speed of the generator 2 is also X Hz. Consequently, the frequency of electricity generated from the generator 2 also becomes X Hz, (for the case of 2-pole generator). Since the gas compressor 6 is directly connected to the electrical motor 5, the gas compressor 6 is driven at the same rotating speed with that of the electrical motor 5. The gas compressor 6 varies the load depending on the rotating speed thereof. According to the example therefore, the inverter 14 adjusts the frequency of the electricity 13 of X Hz, and supplies electricity 38 of Y Hz to the electrical motor 5. With that procedure, the rotating speed of the electrical motor 5 and of the gas compressor 6 can be variable, and the load can be adjusted. As a result, the example allows the gas compressor 6 to operate under a partial load condition.

### Third Embodiment

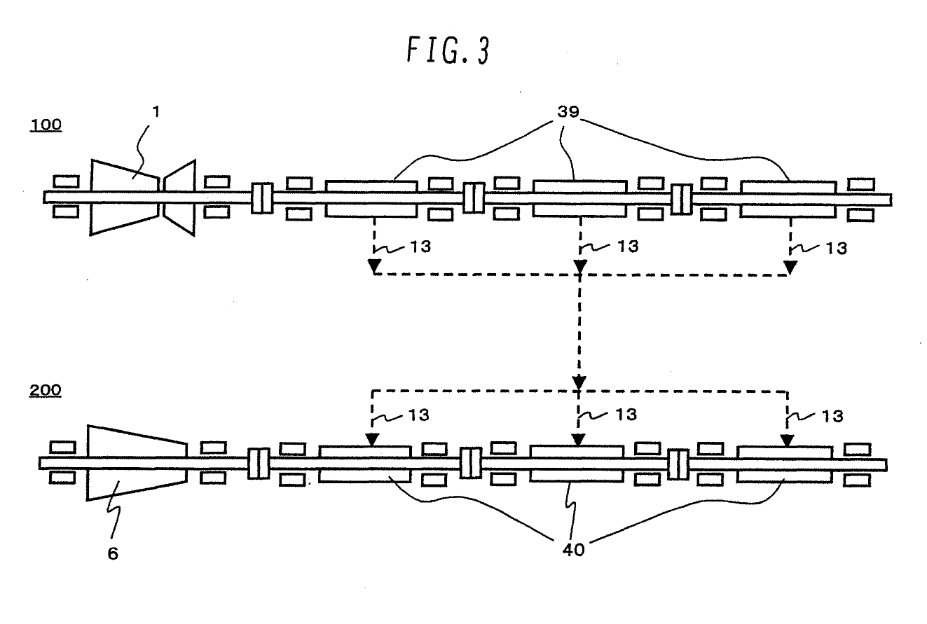

FIG. 3 shows further example of the present invention. Although generators of convention al technology rotate at 50 HZ or 60 Hz of the electrical power supply frequency, the generator of the example rotates at a high speed (X Hz) at or higher than 60 Hz. When the rotor diameter of the generator in the example is the same to that of the convention al generator for 60 Hz, the rotor of the generator is subjected to a centrifugal force of (X/60)² times, which deteriorates the reliability of strength. Therefore, to solve the issue of reliability of strength, the example adopts a generator having smaller diameter shaft than convention al one to decrease the centrifugal force. Since the reduction of the rotor diameter decreases the power generation output, a plurality of generators having small diameter shaft 39 are connected in series to assure necessary output.

Also for the electrical motor, higher rotating speed increases the centrifugal force on the rotor, which deteriorates the reliability of strength. Therefore, also for the electrical motor, a small diameter rotor electrical motor 40 is adopted, and a plurality of motors are connected in series, thus assuring necessary power.

### Fourth Embodiment

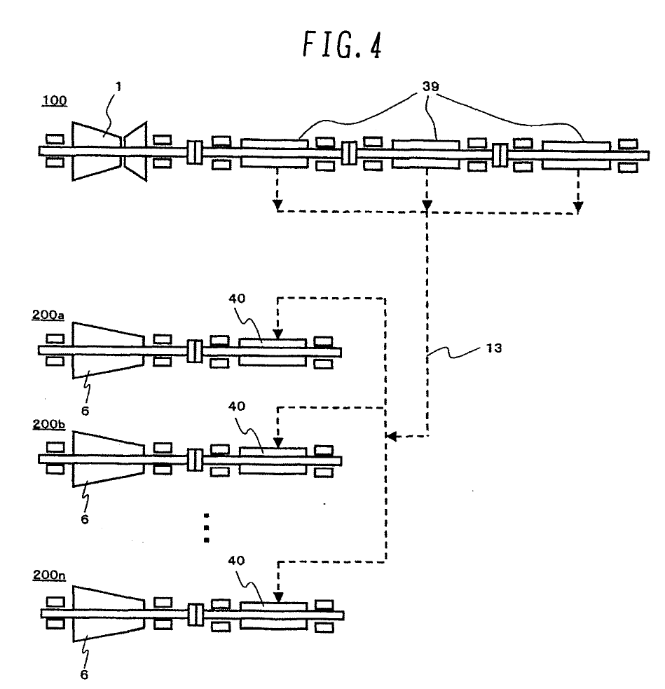

FIG. 4 is a still another example of the present invention. The configuration of the generator side facility 100 having the gas turbine 1 and the small diameter rotor generator 39 is the same to that in FIG. 3. However, the gas compressor 6 and the small diameter rotor electrical motor 40 in the load side facility 200 adopt the ones having small diameter rotors, and arrange plurality of sets (n shafts) of the combination of the gas compressor 6 and the small diameter rotor electrical motor 40. Since the example adopts the small diameter rotors for the gas compressor 6 and the small diameter rotor electrical motor 40, the centrifugal force applied to the rotor is small, thus the reliability becomes high. Furthermore, by varying the number of sets of the operating combination of gas compressor 6 and the small diameter rotor electrical motor 40, the load adjustment becomes available.

### Fifth Embodiment

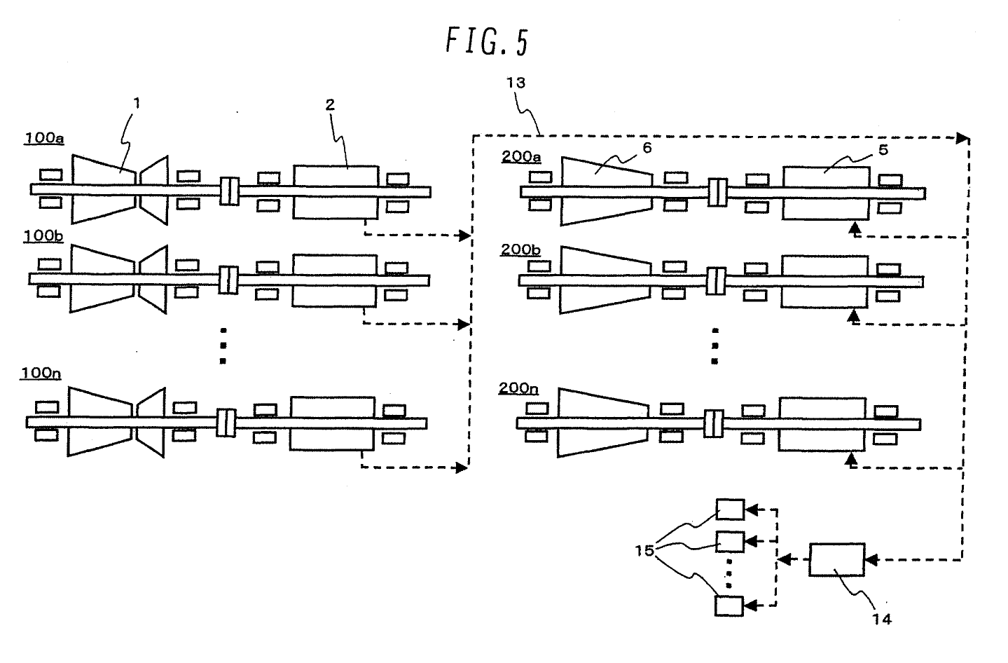

FIG. 5 is a still further example of the present invention. The plant facility according to the example has a plurality of electric power facilities with gas turbine-generator, (100a to 100n), and a plurality of load facilities with electrical motor-gas compressor, (200a to 200n). Each shaft of the electric power facility and each shaft of the load facility are driven for necessary numbers depending on the work volume requested to the plant facility. While the gas compressor 6 is operated, surplus electricity is converted in its frequency to 50 Hz or 60 Hz as ordinary electrical power supply frequency by the inverter 14, thus to drive various kinds of electrical equipment 15 in the plant.

### Sixth Embodiment

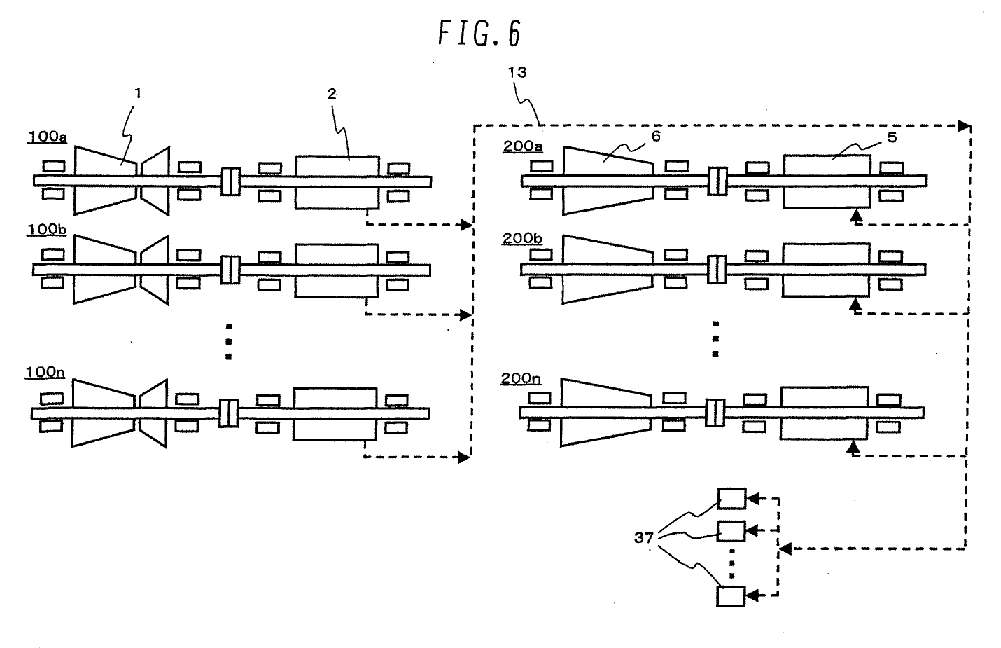

FIG. 6 is still another example of the present invention. According to the example, all the electrical equipment in the plant facility is designed to be driven by electricity of X Hz. Common electrical equipment is generally designed to be driven at 50 HZ or 60 HZ of electrical power supply frequency. Consequently, for using the electrical equipment in the plant facility according to the present invention, an applicable means is that the frequency is converted by provision of an inverter, as shown in FIG. 2. In this case, however, an inverter loss occurs, and an inverter investment arises. Alternatively, another applicable means is that the electricity is supplied from an outside system, without using the electricity generated from the electric power facility within the plant. The means, however, is unreasonable and uneconomical from the point of not-utilizing the in-house electricity generated from the existing electric power facility within the plant for supplying power used in the plant.

Therefore, according to the example, all the electrical equipment 37 in the plant is designed to be driven by electricity of X Hz. As a result, there is no need of using inverter, and no inverter loss occurs, thus the plant efficiency increases. In addition, there is no need of connecting with outside systems, which allows independent operation of the plant.

### Seventh Embodiment

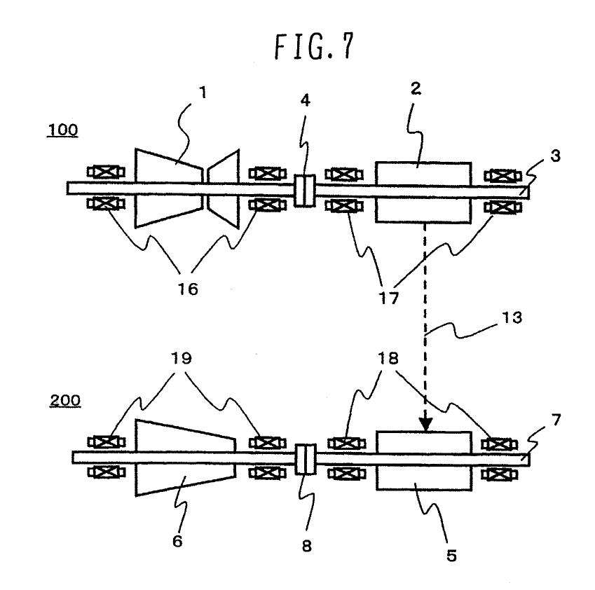

FIG. 7 is still another example of the present invention. The example is the plant facility in which all bearings 16, 17, 18, and 19 for the gas turbine 1, the generator 2, the electrical motor 5, and the gas compressor 6, shown in FIG. 1, respectively, are magnetic bearings. The magnetic bearing is a bearing that suspends the rotor by an electromagnetic attractive force or repulsive force to support the rotor.

Each shaft of convention al gas turbine 1, generator 2, electrical motor 5, and gas compressor 6 is normally supported by slide bearings lubricated by oil. The magnetic bearing, however, does not need lube oil. As a result, the reduction of lube oil consumption can further be promoted in addition to the elimination of reduction gear and speed up gear, which can establish a perfect oil-free plant facility.

Owing to the above arrangement, there is no need of installation of lube oil system equipment such as tank, pump, filter, and cooler, and the number of various valves and the piping length decrease, thereby decreasing the cost. Furthermore, the power to drive auxiliary machines such as pump decreases to increase the plant efficiency. In addition, the installation are a of the plant facility can be significantly decreased.

What is claimed is:

1. A plant facility comprising:
a turbine rotating at a frequency higher than an electrical power supply frequency;
a generator directly connected to said turbine and rotating at a same rotating speed with that of said turbine; and
an electrical motor directly connected to a load apparatus and driven by electricity at a frequency higher than an electrical power supply frequency generated from said generator,
said load apparatus being driven at the same rotating speed with that of said electrical motor.

2. A plant facility comprising a power generator side facility and a load side facility, wherein
said power generator side facility includes a turbine rotating at a frequency higher than an electrical power supply frequency, and a generator directly connected to the turbine and rotating at the same rotating speed with that of said turbine,
said load side facility includes an electrical motor directly connected to the load apparatus,
and wherein electricity having a frequency higher than the electrical power supply frequency generated from said generator drives said electrical motor, and drives the load apparatus connected to the electrical motor at the same rotating speed with that of said electrical motor.

3. A plant facility comprising:
a turbine rotating at a frequency higher than an electrical power supply frequency;
a generator directly connected to the turbine and rotating at the same rotating speed with that of said turbine;
an inverter converting the frequency of electricity generated from the generator; and
an electrical motor directly connected to a load apparatus and driven by electricity having a frequency adjusted by said inverter,
said load apparatus being driven at the same rotating speed with that of said electrical motor.

4. A plant facility comprising:
a turbine rotating at a frequency higher than an electrical power supply frequency;
a plurality of generators each of which is directly connected to the turbine and rotates at the same rotating speed with that of said turbine; and
a plurality of electrical motors each of which is directly connected to a load apparatus and driven by electricity having a frequency higher than the electrical power supply frequency generated from said plurality of generators,
said load apparatus being driven at the same rotating speed with that of said plurality of electrical motors.

5. The plant facility according to claim 1, wherein said electrical motor drives the load apparatus at a frequency higher than 60 Hz.

6. The plant facility according to claim 1, wherein electrical equipment in the plant is driven by electricity at a frequency higher than the electrical power supply frequency.

7. The plant facility according to claim 1, wherein bearings of each rotating machine are magnetic bearings.
